(19) United States
(12) Patent Application Publication
(10) Pub. No.: US 2005/0152278 A1
(43) Pub. Date: Jul. 14, 2005

(54) Traffic balancing for network messages

(76) Inventor: John L. Schantz, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/755,765

(22) Filed: Jan. 12, 2004

(51) Int. Cl. H04L 12/28

(52) U.S. Cl. 370/252

(57) ABSTRACT

A method in a multi-CPU receiving node of a network for routing a SCCP (Signaling Connection Control Part) message to a specific CPU in the multi-CPU receiving node. The method includes applying a mathematical function to information received in the SCCP message to obtain a result. The information includes a first value obtained in a first field of the SCCP message and a second value obtained in a second field of the SCCP message. The method includes employing the result to route the SCCP message to the specific CPU.

### BACKGROUND OF THE INVENTION

SCCP (Signaling Connection Control Part) Class 1 is a network service that guarantees an SCCP user that a message stream (i.e., a series of related messages) will remain in sequence from the SCCP user in the sending note to the SCCP in the destination node in a SS7 network.

SCCP works in cooperation with the MTP (Message Transfer Part) to provide a deterministic path through the SCCP network, which MTP accomplishes via the use of a Signaling Link Selection (SLS) value in the SLS field in each SCCP message in the Class 1 message stream. In ITU (International Telecommunications Union) SS7 networks, for example, the SLS field is 4 bits long, which can provide 16 possible different SLS values. Accordingly, up to 16 unique SLS values can be used between each pair of nodes in the network, as shown in exemplary FIG. 1, to load share the message streams. In ANSI (American National Standards Institute) SS7 networks, the SLS field may be up to 8 bits, and therefore up to 256 SLS values can be used for load sharing on the connections between each pair of nodes in the network.

The number of connections between network nodes is limited by the Signaling Link Code (SLC). The SLC is a 4-bit management field, common between ITU and ANSI networks, and is used in MTP management messages. The SLC limits the number of connections between network nodes to 16.

As network traffic loads increase, the number of message streams received by a node in the network may increase dramatically. These message streams are multiplexed onto a limited number of connections, each of which is allocated unique SLS values to enable routing to a specific connection along a deterministic path in accordance with SCCP class 1 specification. For a node that receives data via multiple connections, a single connection may be allocated only a few SLS values out of the set of available SLS values in order to ensure that its message stream stays in sequence when received at the receiving node. That connection may, however, carry traffic associated with hundreds of message streams, all using the same SLS values.

A problem arises when the receiving node is implemented using multiple CPUs, such as in the case with modern network nodes that are designed to provide a high processing bandwidth. With respect to FIG. 2, such a receiving node is shown by reference number 202. With these multi-CPU nodes, the large number of message streams, e.g., MS0-MS99, associated with any single connection 3 (using only a few SLS values) may need to be load distributed among the receiving node's multiple CPUs (e.g., CPU0-CPUn) for efficient processing. Connection 3 is shown in FIG. 2 by reference number 204. Further, to conform to SCCP class 1 service requirements, related messages in a single message stream must be handled by the same CPU. This is because a message may be sent in fragments, and the same CPU in the receiving node needs to receive all the messages in the message stream in order to reassemble the message properly.

However, since each connection is allocated only a few SLS values as mentioned earlier, it is not possible to rely on the value of the SLS field alone to properly distribute the message streams among a plurality of CPUs in the receiving node both to achieve efficient load-distributing and to comply with the requirements of SCCP class 1 service.

For example, suppose a receiving node in an ITU network receives SCCP messages through 16 connections. In this case, each connection will be allocated one SLS value (e.g., 11) out of the set of 16 possible SLS values in the ITU network. Further, suppose that the connection associated with SLS value 11 carries data associated with 99 different message streams. If the SLS value is employed as the only index for keeping a message stream together in a connection, it is not possible to use the SLS value as an index to distribute the multiple message streams of a given connection among multiple CPUs of the receiving node since these multiple message streams, being associated with a single connection, all share a single SLS value. Unless the load distributing can be achieved in the SCCP class 1 network, a load imbalance among the CPUs may exist in the receiving node, resulting in inefficient use of the receiving node resources.

### SUMMARY OF INVENTION

The invention relates, in an embodiment, to a method in a multi-CPU receiving node of a network for routing a SCCP (Signaling Connection Control Part) message to a specific CPU in the multi-CPU receiving node. The method includes applying a mathematical function to information received in the SCCP message to obtain a result. The information includes a first value obtained in a first field of the SCCP message and a second value obtained in a second field of the SCCP message. The method includes employing the result to route the SCCP message to the specific CPU.

In another embodiment, there is disclosed a telecommunication network having at least one multi-CPU receiving node, the multi-CPU receiving node receiving a plurality of message streams, at least one of the plurality of message streams comprising a plurality of messages. The network includes programmable logic in the multi-CPU receiving node for obtaining a first value and a second value from a SCCP message received at the multi-CPU receiving node. The network further includes programmable logic in the multi-CPU receiving node for obtaining a deterministic result from the first value and the second value, wherein the deterministic result is employed to determine which CPU of the multi-CPU receiving node receives the SCCP message.

In yet another embodiment, the invention relates to a method in a multi-CPU receiving node of a network for routing a SCCP (Signaling Connection Control Part) message to a specific CPU in the multi-CPU receiving node. The method includes applying a mathematical function to information received in the SCCP message to obtain a result. The information includes a first value obtained in a first field of the SCCP message. The mathematical function ensures that a load on any CPU in the multi-CPU receiving node differs by no more than a specified value, e.g., 25%, when sampled over a continuous 24-hour period from a load on any other CPU in the multi-CPU receiving node that is designated for load sharing SCCP message processing. The mathematical function further ensures that messages belonging to a given SCCP message stream are routed to a single CPU of the multi-CPU receiving node. The method also includes employing the result to route the SCCP message to the specific CPU.

In still another embodiment, the invention relates to an article of manufacture comprising a program storage medium having computer readable code embodied therein, the computer readable code being configured to route a SCCP (Signaling Connection Control Part) message to a specific CPU in a multi-CPU receiving node. There is included computer readable code for applying a mathematical function to information received in the SCCP message to obtain a result, the information including a first value obtained in a first field of the SCCP message and a second value obtained in a second field of the SCCP message. There is further included computer readable code for employing the result to select the CPU for routing the SCCP message.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a prior art illustration showing a receiving node in a network.

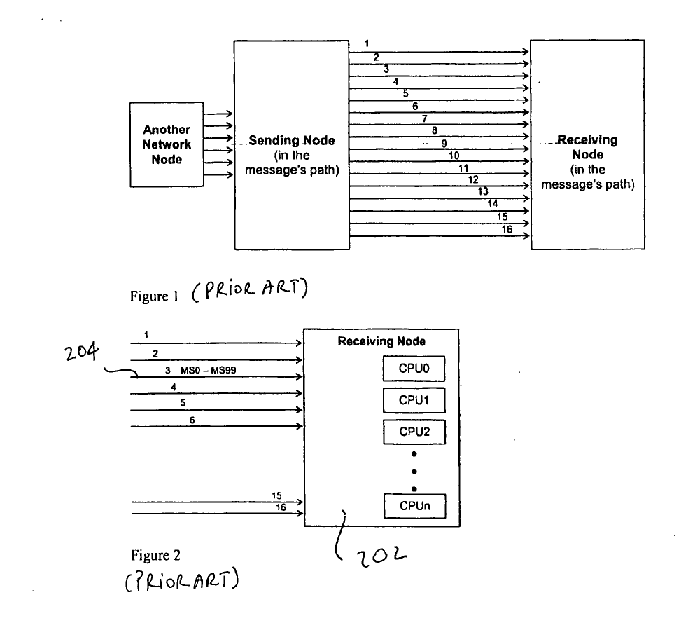

FIG. 2 is a prior art illustration showing a multi-CPU receiving node in a network.

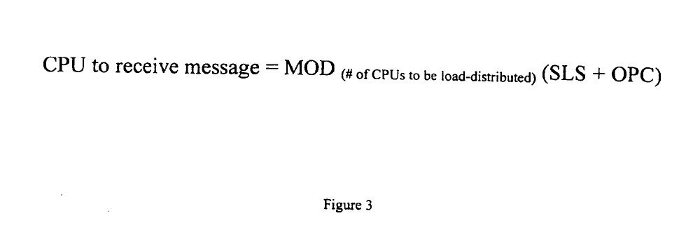

FIG. 3 shows, in accordance with one embodiment of the present invention, the modulo operation employed to select the CPU to receive the SCCP message.

The steps for deciding which CPU to send a received message to is illustrated in FIG. 4, in accordance with one embodiment of the present invention.

### DETAILED DESCRIPTION OF VARIOUS EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. For example, the various hardware components of a typical electronic system (e.g., CPUs, I/Os, memory, keyboard, mouse, optical or magnetic disks, etc.) and/or a typical network (e.g., sending node, receiving node, router, transmission medium, routers, bridges, hubs, etc.) are not discussed in details although they are considered parts of the invention when employed to practice the described method and/or algorithm.

Furthermore, one should keep in mind that the mechanism to execute each of the steps of the described method may be implemented in software and/or hardware. The hardware mechanism may be dedicated in the sense that there is a dedicated hardware logic portion to perform each step. The hardware mechanism may also be programmable in the sense that the same hardware circuitry may be programmed by different codes (e.g., software or firmware) in order to perform different steps of the method at different times. This is more typically the case with modem electronic circuitry, and it is intended that the claims cover both the dedicated hardware situation and the programmable hardware situation. It should be noted in particular that in the claims that follow herein, the same programmable logic (e.g., CPU, programmable array logic, flip-flops, and/or other programmable circuitry), when programmed by different codes to perform different functions at different times, would cover different mechanisms or means to accomplish the various steps of the method since the same programmable logic, while appearing visually unchanged, does indeed behave differently when programmed by different codes.

In accordance with embodiments of the present invention, it is recognized that since the SLS value is nearly a constant for all messages received on a given connection, there exists a need to employ other mechanisms to enable efficient load distribution among the CPUs. The SLS value on a given connection is nearly a constant since, for example, there may be only one SLS value (e.g., 11) or a few SLS values allocated for all messages associated with hundreds of message streams received on a given connection. In various embodiments, the additional mechanism employed for load distribution can be obtained from the messages themselves, and are sufficiently varied to facilitate load distribution with a high degree of granularity.

The inventor herein recognizes that there exists, in the SCCP messages, another field whose value may be employed to distinguish among the message streams. In an embodiment, this additional field is the Originating Point Code (OPC) field, which identifies the message's originating node and is a constant for any single message stream.

The use of the OPC code is also advantageous in that it is a large field (e.g., 24-bit field for ANSI networks), since a node in a modem SS7 network may be expected to receive messages from hundreds or even thousands of originating nodes. The large OPC field ensures that there is sufficient variation from message stream to message stream to achieve load distribution with a high degree of granularity. In fact, one of the advantages of using the OPC is that as the network grows and as a given receiving node is expected to receive messages from a larger number of originating nodes, the more “randomized” the OPC values would appear from the receiving node's perspective (since there is a larger set of originating nodes from which message streams may be sent). In order to maintain sequencing within the same message stream at the same CPU (which necessitates the use of the SLS value) but allow message streams from different originating nodes to be distributed among the CPUs, the inventor herein proposes using both the SLS value and the OPC value in the load distribution decision.

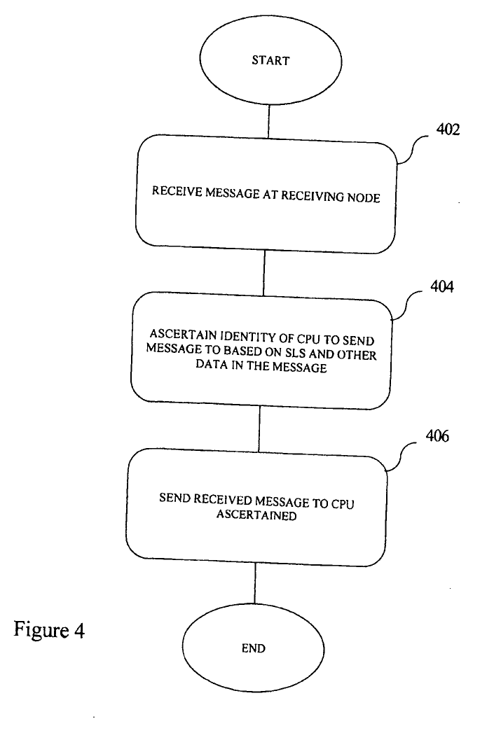

Load distribution is preferably computed in a way so as to minimize the processing overhead at the receiving node. In an embodiment, the load distribution among the CPUs of the receiving node is computed in accordance with the modulo operation (MOD) shown below in Equation 1 and FIG. 3.
CPU to receive message=MOD_{(# of CPUs to be load-distributed)}(SLS+OPC)

wherein the CPU to receive the message is the result computed for each message received at the receiving node. The # of CPUs to be load distributed is the base of the modulo operation and refers to the number of CPUs in the receiving node eligible for sharing the processing load. This number of CPUs to be load distributed may be smaller than the total number of CPUs available in the multi-CPU receiving node since not every CPU executes every application/service (SCCP-user SSN (Sub System Number)), and certain CPUs may be excluded from having to share the processing load pertaining to a particular application. In Equation 1, SLS refers to the SLS value found in the message, while OPC refers to the OPC value found in the message. The sum “SLS+OPC” represents the operand for the modulo operation.

As an example, assuming that the SLS value for a plurality of message streams is 11 and two messages are received in the connection associated with SLS value 11. The first message has an OPC value of 5 and the second message has an OPC value of 6, identifying that these two messages are sent from different sending nodes. Further, assuming that there are 8 CPUs eligible to share the processing load for these messages. Equation 1 will result in a value of 0 for the first message (i.e., a remainder of 0 when 16 is divided by 8) and a value of 1 (i.e., a remainder of 1 when 17 is divided by 8) for the second message. Thus the first message will be sent to CPU0 and the second message will be sent to CPU1.

Note that going forward, all messages with a SLS value of 11 and an OPC value of 5 will be sent to CPU0, while all messages with a SLS value of 11 and an OPC value of 6 will be sent to CPU1. In accordance with an embodiment of the present invention, a table may also be created to map the result of Equation 1 with different CPUs (e.g., computed value 0 maps to CPU5, computed value 1 maps to CPU3, etc.). The table may also be dynamically modified to take into account node or network capabilities and conditions, as appropriate, to achieve better load distribution.

Although the modulo operation is employed as the example operation for determining which CPU would receive an incoming SCCP message, any other functions or formulas can be employed. However, any function or formula employed should result in a deterministic answer (i.e., same CPU) given the same inputs. In various embodiments, these inputs come from values obtained from the SCCP messages themselves (e.g., the SLS and OPC values in the example herein). Furthermore, the function or formula selected should distribute incoming message streams among the CPUs substantially equally. That is, the function or formula selected should not overload any one CPU in the CPU set to be load-distributed.

In an embodiment, the function or formula is selected such that the load on one CPU is different than the load on any other CPU in the set of CPU to load share by no more than 25% when sampled over a continuous 24 hour period. In another embodiment, the function or formula is selected such that the load on one CPU is different than the load on any other CPU in the set of CPU to load share by no more than 5% when sampled over a continuous 24 hour period. In another embodiment, the function or formula is selected such that the load on one CPU is different than the load on any other CPU in the set of CPU to load share by no more than 2% when sampled over a continuous 24 hour period.

The steps for deciding which CPU to send a received message to is illustrated in FIG. 4, in accordance with one embodiment of the present invention. In step 402, a message is received at the receiving node from one of the connections. In step 404, the MOD operation of Equation 1 is computed for the message received in step 402 in order to find out the identity of the CPU that will receive the message. In step 406, the message received in step 402 is forwarded to the CPU identified via the use of Equation 1.

While embodiments of the invention are illustrated with the SCCP class 1 service, it is contemplated that embodiments of the invention may apply equally well to other protocols, including those that have the need for a deterministic path through the network and node or to maintain message sequencing within a message stream. For example, any SS7 MTP user protocol that uses the SLS value to maintain message sequencing or to maintain a deterministic path through the SS7 network may benefit from the invention. One example of such a SS7 MTP user protocol is the ISUP (ISDN User Part) protocol, which is typically employed to set-up and tear-down calls.

As can be appreciated from the foregoing, embodiments of the invention achieve highly granular load distribution of message streams among the multiple-processors of the receiving node in a network without requiring a new protocol, a new data field in the messages, or any hardware changes to the network nodes. By simply updating the software in the receiving node to provide for the CPU selection algorithm (e.g., that shown in Equation 1), embodiments of the invention still allow the messages within a given stream to be sent to a particular CPU in the receiving node, to be kept in sequence, while allowing the multiple processors in the receiving node to process the incoming traffic more efficiently. As the network grows and there are more originating nodes for each receiving node, the CPU selection algorithm becomes even more randomized, improving the granularity of the load distribution.

While this invention has been described in terms of several preferred embodiments, there are alterations, permutations, and equivalents which fall within the scope of this invention. It should also be noted that there are many alternative ways of implementing the methods and apparatuses of the present invention. For example, although the OPC value is employed in conjunction with the SLS value to ensure that the method provides a deterministic value to select the CPU in the example herein, another suitable value or other suitable values (other than the OPC value and/or the SLS value) in the message may well be employed as long as the result is deterministic and the load sharing is substantially equal. It is therefore intended that the following appended claims be interpreted as including all such alterations, permutations, and equivalents as fall within the true spirit and scope of the present invention.

1. In a multi-CPU receiving node of a network, a method for routing a SCCP (Signaling Connection Control Part) message to a specific CPU in said multi-CPU receiving node, comprising:
applying a mathematical function to information received in said SCCP message to obtain a result, said information including a first value obtained in a first field of said SCCP message and a second value obtained in a second field of said SCCP message; and
employing said result to route said SCCP message to said specific CPU.

2. The method of claim 1 wherein said first value represents a Signaling Link Selection (SLS) value, said second value represents an OPC (Originating Point Code) value.

3. The method of claim 2 wherein said applying includes performing a modulo operation on said first value and said second value.

4. The method of claim 3 wherein said modulo operation is
Mod₍ₓ₎(Y+Z)
wherein said X represents a number of CPU to be load distributed in said multi-CPU receiving node, said X represents a base value for said modulo operation, said Y represents said SLS value, said Z represents said OPC value, and said Y+Z represents an operand for said modulo operation.

5. The method of claim 1 wherein said first value represents a Signaling Link Selection (SLS) value.

6. The method of claim 1 wherein said mathematical function represents a function that provides a deterministic result when said first value is a first specific number and said second value is a second specific number.

7. A telecommunication network having at least one multi-CPU receiving node, said multi-CPU receiving node receiving a plurality of message streams, at least one of said plurality of message streams comprising a plurality of messages, comprising:
programmable logic in said multi-CPU receiving node for obtaining a first value and a second value from a SCCP message received at said multi-CPU receiving node; and
programmable logic in said multi-CPU receiving node for obtaining a deterministic result from said first value and said second value, wherein said deterministic result is employed to determine which CPU of said multi-CPU receiving node receives said SCCP message.

8. The telecommunication network of claim 7 wherein said programmable logic for obtaining said deterministic value includes programmable logic for applying a mathematical function to said first value and said second value.

9. The telecommunication network of claim 8 wherein said second value represents an OPC (Originating Point Code) value.

10. The telecommunication network of claim 9 wherein said first value represents a Signaling Link Selection (SLS) value.

11. The telecommunication network of claim 10 wherein said programmable logic for applying a mathematical function includes programmable logic for performing a modulo operation on said first value and said second value, said modulo operation being
Mod₍ₓ₎(Y+Z)
wherein said X represents a number of CPU to be load distributed in said multi-CPU receiving node, said X represents a base value for said modulo operation, said Y represents said SLS value, said Z represents said OPC value, and said Y+Z represents an operand for said modulo operation.

12. The telecommunication network of claim 7 wherein said programmable logic for obtaining said deterministic value includes programmable logic for performing table look up to determine said deterministic value as a function of said first value and said second value.

13. The telecommunication network of claim 12 wherein said second value represents an OPC (Originating Point Code) value.

14. The telecommunication network of claim 13 wherein said first value represents a Signaling Link Selection (SLS) value.

15. In a multi-CPU receiving node of a network, a method for routing a SCCP (Signaling Connection Control Part) message to a specific CPU in said multi-CPU receiving node, comprising:
applying a mathematical function to information received in said SCCP message to obtain a result, said information including a first value obtained in a first field of said SCCP message, said mathematical function ensuring that a load on any CPU in said multi-CPU receiving node differs by no more than 25% when sampled over a continuous 24-hour period from a load on any other CPU in said multi-CPU receiving node that is designated for load sharing SCCP message processing, said mathematical function further ensuring that messages belonging to a given SCCP message stream are routed to a single CPU of said multi-CPU receiving node; and
employing said result to route said SCCP message to said specific CPU.

16. The method of claim 15 wherein said first value represents an OPC (Originating Point Code) value.

17. The method of claim 16 wherein said second value represents a Signaling Link Selection (SLS) value.

18. The method of claim 15 wherein said mathematical function ensures that said load on said any CPU in said multi-CPU receiving node differs by no more than 5% when sampled over said continuous 24-hour period from said load on said any other CPU in said multi-CPU receiving node that is designated for said load sharing SCCP message processing.

19. The method of claim 15 wherein said mathematical function ensures that said load on said any CPU in said multi-CPU receiving node differs by no more than 2% when sampled over said continuous 24-hour period from said load on said any other CPU in said multi-CPU receiving node that is designated for said load sharing SCCP message processing.

20. An article of manufacture comprising a program storage medium having computer readable code embodied therein, said computer readable code being configured to route a SCCP (Signaling Connection Control Part) message to a specific CPU in a multi-CPU receiving node, comprising:
computer readable code for applying a mathematical function to information received in said SCCP message to obtain a result, said information including a first value obtained in a first field of said SCCP message and a second value obtained in a second field of said SCCP message; and
computer readable code for employing said result to select said CPU for routing said SCCP message.

21. The article of manufacture of claim 20 wherein said first value represents a Signaling Link Selection (SLS) value, said second value represents an OPC (Originating Point Code) value.

22. The article of manufacture of claim 21 wherein said computer readable code for applying includes computer readable code for performing a modulo operation on said first value and said second value.

23. The article of manufacture of claim 22 wherein said modulo operation is
Mod₍ₓ₎(Y+Z)
wherein said X represents a number of CPU to be load distributed in said multi-CPU receiving node, said X represents a base value for said modulo operation, said Y represents said SLS value, said Z represents said OPC value, and said Y+Z represents an operand for said modulo operation.

24. The article of manufacture of claim 20 wherein said first value represents a Signaling Link Selection (SLS) value.

25. The article of manufacture of claim 20 wherein said mathematical function represents a function that provides a deterministic result when said first value is a first specific number and said second value is a second specific number.
